(19) United States
(12) Patent Application Publication
(10) Pub. No.: US 2012/0168580 A1
(43) Pub. Date: Jul. 5, 2012

(54) Closed Cell Foam Suction Device

(76) Inventor: Douglas Mackey, Bainbridge Island, WA (US)

(21) Appl. No.: 12/983,306

(22) Filed: Jan. 1, 2011

(51) Int. Cl. F16B 47/00

(52) U.S. Cl. 248/205.5

(57) ABSTRACT

A suction device formed by cutting, molding or heat stamping a shape into closed cell foam material.

### CROSS-REFERENCE TO RELATED APPLICATIONS

This application claims priority to Provisional No. 61/335,225 filed on Jan. 4, 2010, inventor Douglas Mackey, entitled “Suction Dimple”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Suction devices are well known. In many cases they are referred to as suction cups. They are generally used to permanently or temporarily attach objects to supporting surfaces. In manufacturing products and toys for use in bath tubs and showers, manufactures often use closed cell foam material because it does not absorb water, it floats, and it is bacteria resistant. There is often a need to attach the product to the bath/shower wall. To meet this need manufactures typically use suction cups with the product, or rely on the cling created by the covalent bonds between water molecules, supporting surfaces and closed cell foam. The problem with suction cups is that they add an extra component, along with additional costs and complexity, to the product. The problem with relying on the cling created by covalent bonds, is the weak connection between the product and the supporting wall. Therefore a suction device that overcomes the above described and other disadvantages is needed.

### BRIEF SUMMARY OF THE INVENTION

The disclosed invention relates to a suction device formed in closed cell foam by cutting, molding or stamping a suction cavity into the material. By using this suction devise a simple, low cost, easy to operate effective suction solution is created.

### BRIEF DESCRIPTION OF THE SEVERAL VIEWS OF THE DRAWINGS

The present disclosure will be better understood by those skilled in the pertinent art by referencing the accompanying drawings, where like elements are numbered alike in the several figures, in which:

FIG. 1 is a perspective view of the disclosed suction device 1.

FIG. 2 is a sectional view of the disclosed suction device 1 applied to supporting surface 5.

FIG. 3 is a perspective view of the disclosed suction device 1 with various sizes, shapes, depths, and concavities.

FIG. 4 is a perspective view of the disclosed suction device 1 integrated into closed cell foam product 6.

FIG. 5 is a perspective view of the disclosed suction device 1 attached to product 7.

FIG. 6 shows another embodiment of the disclosed suction device 1 attached to product 7. In this view the suction device is made in the form of a gasket.

### DETAILED DESCRIPTION OF THE INVENTION

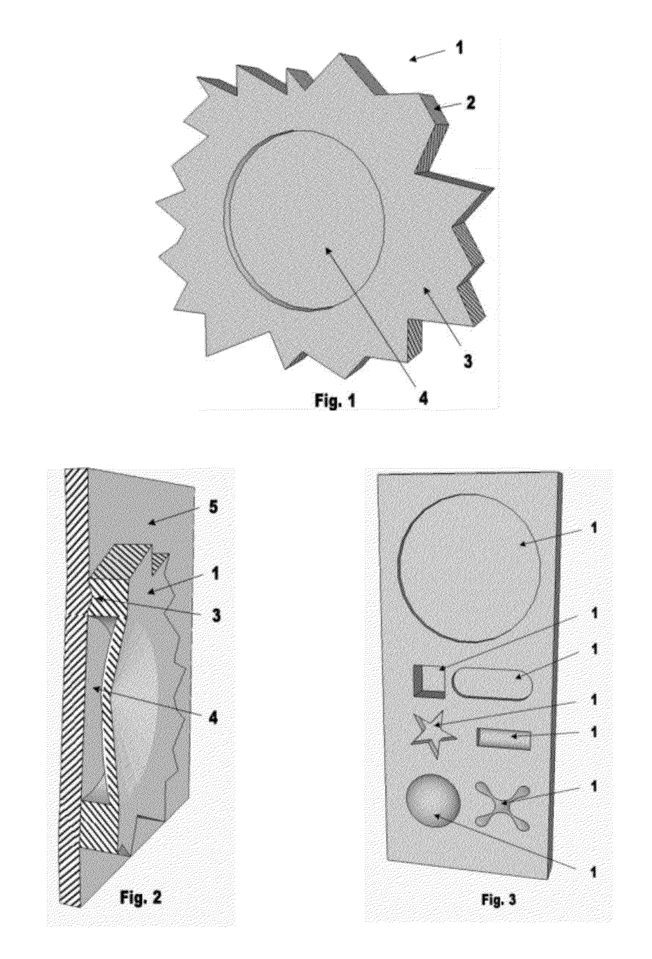

FIG. 1 is a perspective view of the disclosed suction device 1. This suction device is made of closed cell foam material 2. This suction device has at least one flat face serving as sealing face 3 that creates a temporary or permanent airtight seal when the suction device is applied to supporting surface 5 (FIG. 2). The suction device has at least one cavity formed into flat face serving as suction cavity 4. One of ordinarily skill in the art will recognize that the suction device may be stamped, cut, molded or manufactured by other methods from closed cell foam material.

FIG. 2 is a sectional view of the disclosed suction device 1 applied to supporting surface 5. This suction device is made of closed cell foam of a density such that the sealing face 3 can conform to, and maintain a seal around, imperfections of supporting surface 5. This suction device is made of closed cell foam of a density such that the suction cavity 4 deforms and shrinks in volume as the suction device is applied to supporting wall surface 5. This suction device is made of closed cell foam of a density such that the suction cavity 4 regains volume after it is applied to supporting surface 5 with enough force to create a suction between suction device 1 and supporting surface 5.

FIG. 3 is a perspective view of the disclosed suction device with various sizes, shapes, depths, and concavities. One of ordinarily skill in the art will recognize that the size, shape, depth and concavity of the suction device may be varied to accommodate different requirements and conditions.

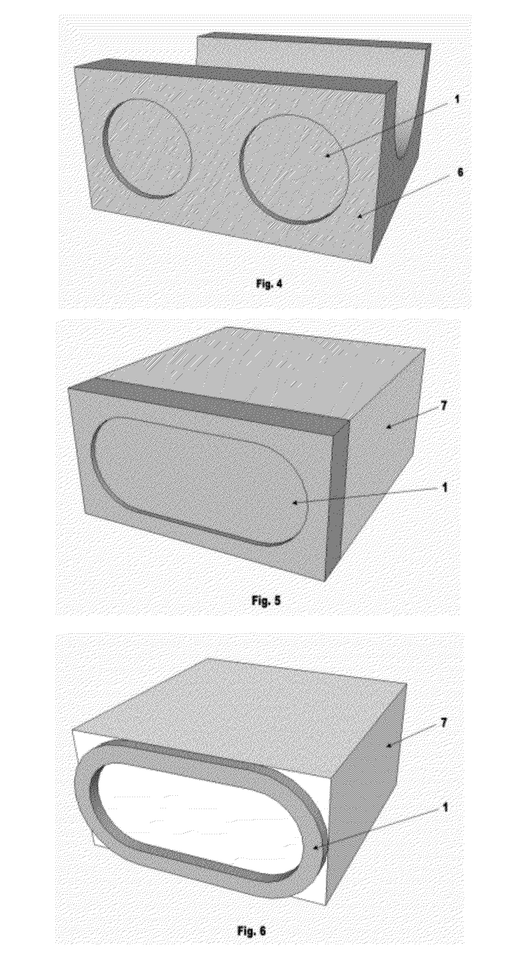

FIG. 4 is a perspective view of the disclosed suction device 1 integrated into closed cell foam product 6.

FIG. 5 is a perspective view of the disclosed suction device 1 attached to product 7. One of ordinarily skill in the art will recognize that the suction device may be permanently, or temporarily, attached to product 7.

FIG. 6 shows another embodiment of the disclosed suction device 1 attached to product 7. In this view the suction device 1 is made in the form of a gasket. One of ordinarily skill in the art will recognize that the suction device may be permanently, or temporarily, attached to product 7.

The first advantage of the disclosed suction device is low cost. In cases where the primary product to be supported is manufactured from closed cell foam of the correct density, the disclosed suction device can be integrated directly into a flat surface of primary product. In cases where the primary product is made from another material the disclosed suction device can be inexpensively manufactured from closed cell foam material and attached temporarily or permanently to primary product.

The second advantage is simple operation. Because the disclosed suction device is integrated, or attached, directly to the primary product it is not necessary to connect the product to the suction device before/after use. Additionally, it is not necessary to separately align the suction cup before applying to supporting wall. Both of these advantages mean that only one hand is required to operate the disclosed suction device. Simple operation is an important advantage for children's products and for products used in slippery, relatively unsafe environments.

It should be noted that the terms “first”, “second” do not imply a spatial, sequential, or hierarchical order to the modified elements.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

1. Suction device comprising: closed cell foam material; having at least one flat face serving as sealing face; having at least one cavity formed into flat face serving as suction cavity.

2. The suction device of claim 1, where the suction device is integrated into a closed cell foam product.

3. The suction device of claim 1, where the suction device is connected temporarily or permanently to a product.
